(19) United States
(12) Patent Application Publication
(10) Pub. No.: US 2022/0369428 A1
(43) Pub. Date: Nov. 17, 2022

(54) CERAMIC HEATER AND MANUFACTURING METHOD THEREFOR

(71) Applicant: MICO CERAMICS LTD., Gyeonggi-do (KR)

(72) Inventor: Je Ho CHAE, Pyeongtaek-si (KR)

(21) Appl. No.: 17/638,174

(22) PCT Filed: Jan. 7, 2020
(86) PCT No.: PCT/KR2020/000274

§ 371 Date: Feb. 24, 2022

(30) Foreign Application Priority Data
Oct. 22, 2019 (KR) 10-2019-0131085

(51) Int. Cl. H05B 3/48; H05B 3/03; H05B 3/14

(52) U.S. Cl. CPC H05B 3/48; H05B 3/03; H05B 3/143

(57) ABSTRACT

The present invention relates to a ceramic heater with improved reliability, comprising: a heater body provided with a high-frequency electrode made of a mesh type metal material, and an electrode rod connecting member that contacts the bottom surface of the high-frequency electrode; and a heater support that is mounted below the heater body and supports the heater body, wherein the high-frequency electrode comprises a first electrode member having a wire type mesh structure and a second electrode member having a sheet type mesh structure.

### FIELD OF THE INVENTION

The disclosure relates to a ceramic heater and a method for manufacturing the same and, more particularly, to a ceramic heater having improved reliability and a method for manufacturing the same.

### BACKGROUND OF THE INVENTION

In general, a semiconductor device or display device is manufactured by successively laminating multiple thin film layers including a dielectric layer and a metal layer on a glass substrate, flexible substrate, or semiconductor wafer substrate, and then patterning the same. These thin film layers are successively deposited on a substrate through a chemical vapor deposition (CVD) process or physical vapor deposition (PVD) process. Examples of the CVD process includes a low-pressure CVD (LPCVD) process, a plasma enhanced CVD (PECVD) process, and a metal organic CVD (MOCVD) process.

Such CVD devices and PVD devices have heaters disposed to support a glass substrate, a flexible substrate, a semiconductor wafer substrate, and the like and to apply predetermined heat. The heaters are used to heat substrates also during a process for etching thin film layers formed on a support substrate, during a photoresist sintering process, and the like. Ceramic heaters are widely used as the heaters installed for the CVD devices and PVD devices according to requirements such as accurate temperature control, micro-wiring of semiconductor elements, and precise heat treatment of semiconductor wafer substrates.

FIG. 1A is a diagram illustrating the configuration of a ceramic heater according to the prior art. As illustrated in FIG. 1A, the ceramic heater 1 may be used to support a substrate such as a wafer during a semiconductor manufacturing process and to heat the substrate to a process temperature, for example, temperature for performing a CVD process or PVD process.

The conventional ceramic heater 1 includes a ceramic body 10 having a circular plate shape structure and a ceramic support portion 20 mounted on the lower portion of the ceramic body 10. The ceramic body 10 includes a high-frequency electrode (or ground electrode) 11 configured to discharge an electric current accumulated in the ceramic heater 1 to the ground during plasma generation, a heating element 13 configured to generate heat energy for heating a substrate, a first rod connecting member 12 configured to electrically connect the high-frequency electrode 11 and a ground rod 21, and a second rod connecting member 14 configured to electrically connect the heating element 13 and a heating element rod 23. The ceramic support portion 20 includes a ground rod 21 configured to connect the high-frequency electrode 11 to the ground, and a heating element rod 23 configured to connect the heating element 13 to an external power supply (not illustrated).

The high-frequency electrode 11 buried in the ceramic heater 1 is made of a metal material having a high melting point capable of playing the role of plasma ground, and is generally manufactured in a wire type mesh structure in which metal wires arranged in a first direction and metal wires arranged in a second direction intersect perpendicularly with each other and formed in a fabric type. The first rod connecting member 12 contacts a surface of the high-frequency electrode 11 having such a wire type mesh structure. However, there is a problem in that, if the conventional ceramic heater 1 is used for a long period of time, cracks frequency occur in the area of contact between the high-frequency electrode 11 and the first rod connecting member 12.

For example, as illustrated in FIG. 1B, the conventional ceramic heater 1 is manufactured through a hot press process, and during the hot press process, a predetermined pressure is delivered along an axis and in a direction (for example, vertical direction in the drawing) to sinter ceramic powder. In this case, nonuniform pressure is delivered to the area of contact between the high-frequency electrode 11 having a wire mesh type shape and the first rod connecting member 12 due to structural interference of the three-dimensional shape, and a micro crack thus exists in the area of contact.

Such a ceramic heater 1 undergoes a repeated process of heat up & down during semiconductor processes, and entire thermal stress caused by thermal expansion of the first rod connecting member 12 and the high-frequency rod 11 made of a metal material is delivered to the ceramic body 10. Therefore, there is a problem in that the micro crack existing in the area of contact between the high-frequency electrode 11 and the first rod connecting member 12 grows bigger and reaches the surface of the ceramic body 10.

### BRIEF SUMMARY OF THE INVENTION

It is an aspect of the disclosure to solve the above-mentioned problems and other problems. It is another aspect of the disclosure to provide a ceramic heater having improved reliability and a method for manufacturing the same.

It is still another aspect of the disclosure to provide a ceramic heater including a high-frequency electrode obtained by coupling a first electrode member having a wire-type mesh structure and a second electrode member a sheet-type mesh structure, and a method for manufacturing the same.

In order to solve the above-mentioned or other problems, an aspect of the disclosure provides a ceramic heater including: a heater body including a high-frequency electrode made of a mesh type metal material and an electrode rod connecting member in contact with a lower surface of the high-frequency electrode; and a heater support mounted to a lower portion of the heater body to support the heater body, wherein the high-frequency electrode includes a first electrode member having a wire type mesh structure and a second electrode member having a sheet type mesh structure.

In addition, the first electrode member may include a plurality of wire type metals arranged in a first direction and a plurality of wire type metals arranged in a second direction perpendicular to the first direction. In addition, the first electrode member may include an opening corresponding to a shape of the second electrode member. In addition, the opening may be formed at a position of the first electrode member corresponding to a position of the electrode rod connecting member.

In addition, the second electrode member may have a size larger than the opening formed in the first electrode member. In addition, the second electrode member may be disposed to cover the opening formed at the first electrode member. In addition, the second electrode member may be formed to be greater than the area of a contact surface of the electrode rod connecting member in contact with the high-frequency electrode.

In addition, the second electrode member may include a plurality of sheet type metals arranged in a first direction and a plurality of sheet type metals arranged in a second direction perpendicular to the first direction. In addition, the second electrode member may be formed by processing a plurality of grooves on a metal sheet. In addition, the second electrode member may have a thickness thinner than the first electrode member. In addition, the second electrode member may be bonded to the first electrode member via a hot press process.

### BRIEF DESCRIPTION OF THE DRAWINGS

FIG. 1A is a view illustrating a configuration of a ceramic heater according to a prior art;

FIG. 1B is an enlarged view of part A illustrated in FIG. 1A flipped upside down;

FIG. 2 is a perspective view illustrating an exterior of a ceramic heater according to an embodiment of the disclosure;

FIG. 3 is a cross-sectional view illustrating a configuration of a ceramic heater according to an embodiment of the disclosure;

FIG. 4 is an enlarged view of part B illustrated in FIG. 3 flipped upside down;

FIGS. 5A to 5C are views illustrating a shape of a high-frequency electrode according to an embodiment of the disclosure;

FIGS. 6A to 6C are views illustrating a shape of a high-frequency electrode according to another embodiment of the disclosure;

FIG. 7 is a flowchart illustrating a method for manufacturing a heater body constituting the ceramic heater in FIG. 3;

FIG. 8 is a view referred to for explaining a method for manufacturing a heater body constituting the ceramic heater in FIG. 3; and

FIG. 9A to FIG. 9E are views illustrating a method for manufacturing a ceramic molded body according to an embodiment of the disclosure.

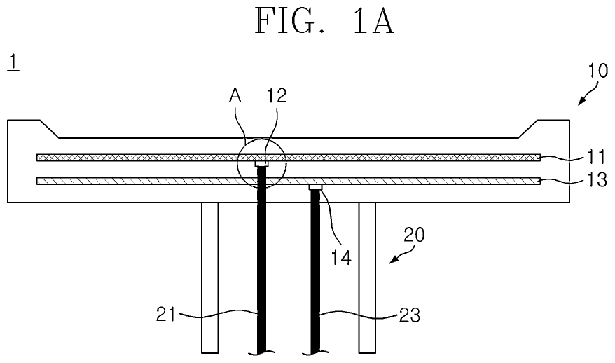

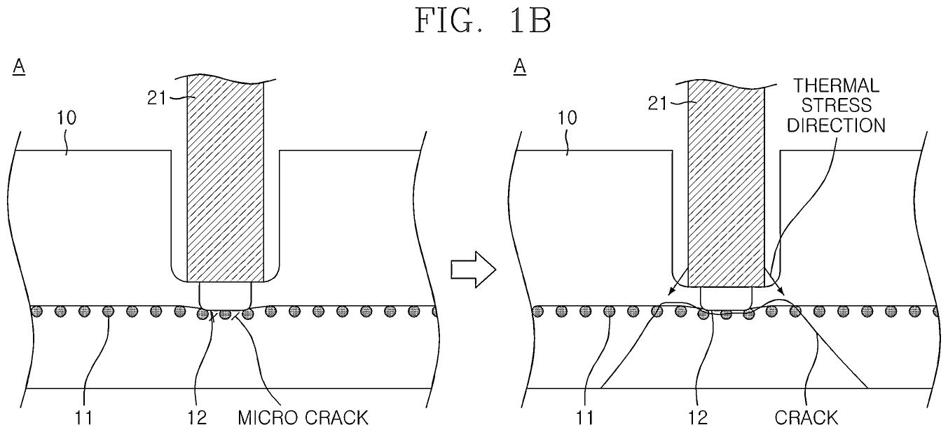

### DETAILED DESCRIPTION OF THE INVENTION

Hereinafter, embodiments of the present disclosure will be described in detail with reference to the accompanying drawings, the same or similar components will be denoted by the same reference numerals regardless of drawing numerals, and redundant description thereof will be omitted. Hereinafter, in the description of an embodiment according to the disclosure, when it is described that each layer (film), region, pattern, or structures is formed “on” or “under” each layer (film), region, pad, or patterns, the wording “on” or “under” includes all the cases of being formed “directly” and “indirectly while interposing another layer therebetween”. In addition, the drawings will serve as a reference in connection with being “on” or “under” each layer. The thickness or size of each layer in the drawings is exaggerated, omitted, or schematically illustrated for convenience and clarity of description. In addition, the size of each component does not completely reflect the actual size.

In addition, in describing an embodiment disclosed herein, a detailed description of known relevant technologies will be omitted when it may make the subject matter of the embodiment disclosed herein rather unclear. In addition, the accompanying drawings are merely intended to facilitate understanding of the embodiments disclosed herein and not to restrict the technical spirit disclosed herein by the accompanying drawings. In addition, the accompanying drawings should be understood as covering all modifications, equivalents, or alternatives included in the spirit and scope of the present disclosure.

The disclosure proposes a ceramic heater having improved reliability and a method for manufacturing same. In addition, the disclosure proposes a ceramic heater and a method for manufacturing same, the ceramic heater including a high-frequency electrode in which a first electrode member having a wire type mesh structure and a second electrode member having a sheet type mesh structure are coupled to each other.

Hereinafter, various embodiments of the disclosure will be described in detail with reference to the drawings.

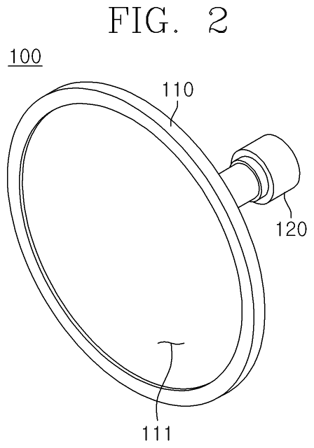

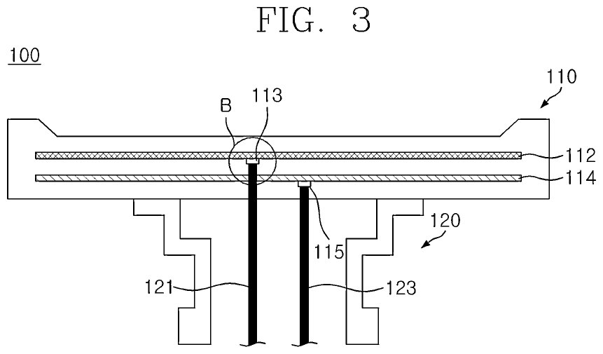

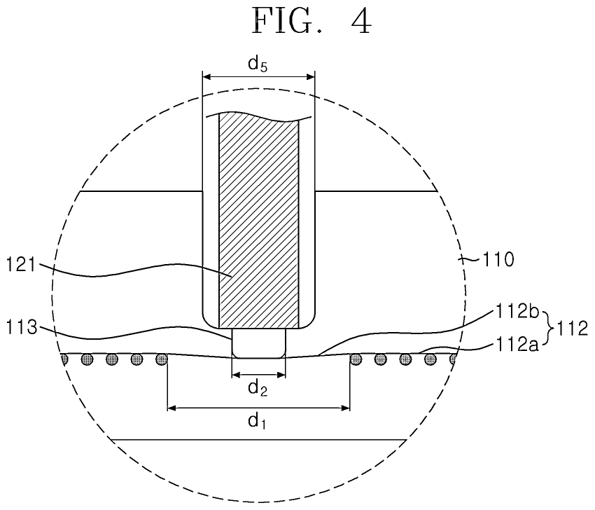

FIG. 2 is a perspective view illustrating an exterior of a ceramic heater according to an embodiment of the disclosure, FIG. 3 is a cross-sectional view illustrating a configuration of a ceramic heater according to an embodiment of the disclosure, and FIG. 4 is an enlarged view of part B illustrated in FIG. 3 flipped upside down.

Referring to FIG. 2 to FIG. 4, a ceramic heater 100 according to an embodiment of the disclosure is a semiconductor device configured to support heat treatment objects for various purposes such as a semiconductor wafer, a glass substrate, and a flexible substrate and heat the corresponding heat treatment object to a predetermined temperature.

The ceramic heater 100 includes a heater body 110 configured to transmit heat while stably supporting a heat treatment object (not illustrated), and a heater support 120 mounted to a lower portion of the heater body 110. Meanwhile, although not illustrated, an adhesive layer (not illustrated) may be formed between the heater body 110 and the heater support 120.

The heater body 110 may be formed of a plate-shaped structure having a predetermined shape. For example, the heater body 110 may be formed of a circular plate-shaped structure, but is not necessarily limited thereto.

A pocket region 111 (or a cavity region) having a structure recessed with a predetermined step may be formed at an upper portion of the heater body 110 so that a heat treatment object such as a wafer is stably mounted. An upper surface of the heater body 110, which corresponds to the pocket region, may be formed to have an excellent flatness. This is to horizontally dispose a heat treatment object installed in a chamber without tilting in one direction.

The heater body 110 may include a plurality of ceramic plates (not illustrated) formed of a ceramic material with excellent heat conductivity and may be formed by performing a compression sintering process on the plurality of ceramic plates. Here, the ceramic material may be at least one of Al₂O₃, Y₂O₃, Al₂O₃/Y₂O₃, ZrO₂, autoclaved lightweight concrete (AlC), TiN, AlN, TiC, MgO, CaO, CeO₂, TiO₂, BₓC_{y}, BN, SiO₂, SiC, YAG, mullite, and AlF₃, and more preferably, may be aluminum nitride (AlN).

The heater body 110 may include a high-frequency electrode 112, a first rod connecting member 113 in contact with a lower surface of the high-frequency electrode 112, a heating element disposed under the high-frequency electrode 112, and a second rod connecting member 115 in contact with a lower surface of the heating element 114.

The high-frequency electrode 112 (or a ground electrode) may be buried in an upper portion of the heater body 110 and may be formed in a circular plate shape. The high-frequency electrode 112 may be an electrode layer for plasma enhancement chemical vapor deposition to be selectively connected to an RF power source or connected to the ground.

The high-frequency electrode 112 may include a first electrode member 112a having a wire type mesh structure and a second electrode member 112b having a sheet type mesh structure. Here, the wire type mesh structure is a structure having a three-dimensional shape and is a mesh structure in which a plurality of wire type metals arranged in a first direction and a plurality of wire type metals arranged in a second direction are formed to cross each other to be perpendicular to each other. Furthermore, the sheet type mesh structure is a structure having a two-dimensional shape, and is a mesh structure in which a plurality of sheet type metals arranged in a first direction and a plurality of sheet type metals arranged in a second direction are formed to cross each other to be perpendicular to each other or a mesh structure formed by processing a plurality of grooves on a metal sheet.

The first electrode member 112a may be formed in a circular plate shape. An opening corresponding to the shape of the second electrode member 112b may be formed at a central portion of the first electrode member 112a. The second electrode member 112b may be coupled to the central portion to cover the opening formed at the central portion of the first electrode member 112a. Accordingly, the first electrode member 112a and the second electrode member 112b are integrally coupled to form one high-frequency electrode 112.

The second electrode member 112b may be formed in a circular plate shape having a predetermined diameter d1. In this case, the diameter d1 of the second electrode member 112b may be formed to be greater than a diameter d2 of a contact surface of the first rod connecting member 113.

The high-frequency electrode 112 may be formed of tungsten (W), molybdenum (Mo), silver (Ag), gold (Au), niobium (Nb), titanium (Ti), aluminum nitride (AlN), or an alloy thereof, and more preferably, may be formed of molybdenum (Mo).

Said high-frequency electrode 112 may selectively perform one of a radio frequency (RF) grounding function and an electrostatic chuck function. Here, the wording “RF grounding function” means a function of discharging the current charged in the heater body 110 by the plasma inside the chamber to an external ground in a wafer deposition process. In addition, the wording “electrostatic chuck function” means a function of bringing a heat treatment object such as a wafer into close contact with the upper surface of the heater body 110 by using an electric field.

The heating element 114 may be buried in a lower portion of the heater body 110 and may be formed in a shape corresponding to a shape of a heat treatment object. The heating element 114 may be disposed at a lower portion of the high-frequency electrode 112 to be spaced a predetermined distance apart from the high-frequency electrode 112.

The heating element 114 may be buried in the heater body 110 corresponding to the position of the heat treatment object. In addition, the heating element 114 may be buried in the heater body 110 to be parallel to the heat treatment object so as to not only uniformly control the heating temperature according to the position in order to uniformly heat the heat treatment object as a whole but also maintain the distance by which heat is transferred to the heat treatment object to be constant at almost all positions.

The heating element 114 may be formed in a flat plate shape or a plate coil shape by a heating wire (or a resistance wire). In addition, the heating element 114 may be formed in a multi-layered structure to precisely control the temperature.

Said heating element 114 performs a function of heating a heat treatment object positioned on an upper surface of the heater body 110 to a constant temperature to perform smooth deposition process and etching process in a semiconductor manufacturing process.

The first rod connecting member 113 (or an electrode rod connecting member) is in contact with a lower surface of the high-frequency electrode 112 to perform a function of electrically connecting the high-frequency electrode 112 and a first rod 121.

The first rod connecting member 113 may be in contact with one surface of the second electrode member 112b having a sheet type mesh structure positioned on a lower surface of the high-frequency electrode 112. In this case, the first rod connecting member 113 may be attached to the second electrode member 112b via a brazing process but is not necessarily limited thereto.

The second rod connecting member 115 (or a heating element rod connecting member) is in contact with a lower surface of the heating element 114 to perform a function of electrically connecting the heating element 114 and a second rod 123.

The first and second rod connecting members 113 and 115 may be made of a metal material having excellent electrical conductivity. For example, the first and second rod connecting members 113 and 115 may be formed of tungsten (W), molybdenum (Mo), silver (Ag), gold (Au), niobium (Nb), titanium (Ti), or an alloy thereof, and more preferably, may be formed of molybdenum (Mo).

The heater support 120 is mounted to a lower portion of the heater body 110 to perform a function of supporting the heater body 110. Accordingly, the heater support 120 is coupled to the heater body 110 to form the ceramic heater 100 having an overall T-shape.

The heater support 120 may be formed in a cylindrical tubular shape having an empty space formed therein. This is to install the plurality of rods 121 and 123 connected to the high-frequency electrode 112 and the heating element 114 of the heater body 110 via the heater support 120.

The heater support 120 may be formed of a ceramic material having the same main components as the heater body 110. For example, the heater support 120 may be formed of at least one material of Al₂O₃, Y₂O₃, Al₂O₃/Y₂O₃, ZrO₂, autoclaved lightweight concrete (AlC), TiN, AlN, TiC, MgO, CaO, CeO₂, TiO₂, BₓC_{y}, BN, SiO₂, SiC, YAG, Mullite, and AlF₃, and more preferably, may be formed of aluminum nitride (AlN).

The first rod 121 (or an electrode rod) may be installed in the heater support 120 to perform a function of electrically connecting the first rod connecting member 113 and an external ground (not illustrated). Accordingly, the high-frequency electrode 112 buried in the heater body 110 may be electrically connected to an RF power source or an external ground via the first rod 121.

The second rod 123 (or a heating element rod) may be installed in the heater support 120 to perform a function of electrically connecting the second rod connecting member 115 and an external power source device (not illustrated). Accordingly, the heating element 114 buried in the heater body 110 may be electrically connected with the external power source device via the second rod 123.

The first and second rods 121 and 123 may be formed of a metal material having an excellent electrical conductivity. For example, the first and second rods 121 and 123 may be formed of copper (Cu), aluminum (Al), iron (Fe), tungsten (W), nickel (Ni), silver (Ag), gold (Au), niobium (Nb), titanium (Ti), or an alloy thereof, and more preferably, may be formed of nickel (Ni).

As described above, a ceramic heater according to an embodiment of the disclosure may include a high-frequency electrode in which a first electrode member having a wire type mesh structure and a second electrode member having a sheet type mesh structure are integrally coupled so as to induce uniform pressure to be transmitted to a contact portion between the high-frequency electrode and the first rod connecting member when manufacturing a ceramic heater by using a hot press process, and thus can effectively prevent the occurrence of a crack at the contact portion.

Meanwhile, table 1 below is a table showing the results of experiments on whether cracks occur in the ceramic heater according to the prior art and the ceramic heater according to the present embodiment. Here, the comparative example is an example of experimenting with the ceramic heater according to the prior art, example 1 is an example of experimenting with a ceramic heater including an electrode member having a sheet type mesh structure having a first diameter (6 mm), and example 2 is an example of experimenting with a ceramic heater including an electrode member having a sheet type mesh structure having a second diameter (9 mm). In addition, in the above comparative example and examples, experiments were conducted on ceramic heaters having the same rod hole size (6 mm) as each other. Here, as illustrated in FIG. 4, the rod hole size d5 means the size of the opening formed in the corresponding body part 110 to insert the first rod 121 into the heater body 110.

TABLE 1

| | Presence | | | | |
|---|---|---|---|---|---|
| | or absence | | Sheet type | Whether | Whether |
| | of sheet | The rod | electrode | there is | there is |
| | type | hole size | diameter | internal | surface |
| No. | electrode | (mm) d5 | (mm) d1 | crack | crack |
| Comparative | X | 6 | X | ◯ | ◯ |
| example | | | | | |
| Example 1 | ◯ | 6 | 6 | X | X |
| Example 2 | ◯ | 6 | 9 | X | X |

As shown in Table 1 above, in the case of the ceramic heater according to the comparative example (that is, in the case of a ceramic heater which does not include an electrode member having a sheet type mesh structure), it can be confirmed that cracks occur inside and on the surface of the ceramic heater. On the other hand, in the case of the ceramic heater according to the present embodiments (that is, in the case of the ceramic heater including the electrode member having the sheet type mesh structure), it can be confirmed that no cracks occur inside and on the surface of the ceramic heater.

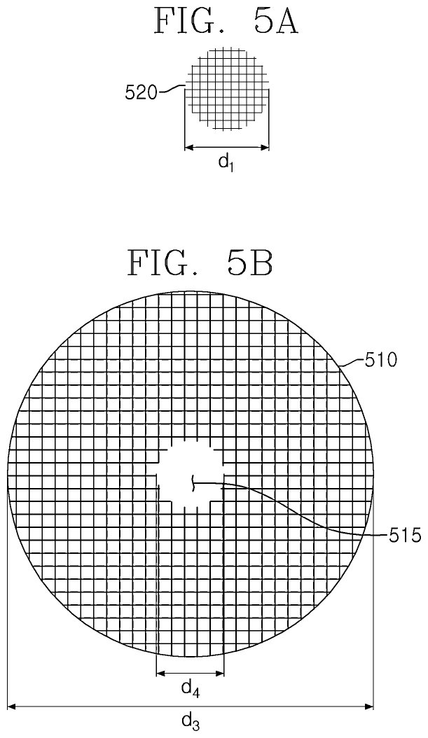

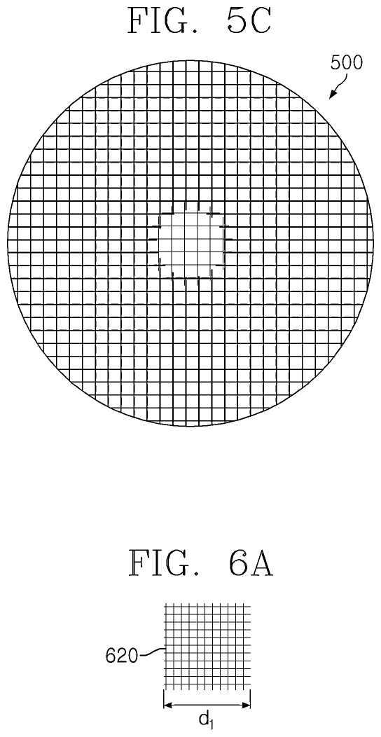

FIGS. 5A to 5C are views illustrating a shape of a high-frequency electrode according to an embodiment of the disclosure.

Referring to FIGS. 5A to 5C, a high-frequency electrode 500 according to an embodiment of the disclosure includes a first electrode member 510 having a wire type mesh structure and a second electrode member 520 having a sheet type mesh structure 520.

The first electrode member 510 may be formed in a mesh structure in which a plurality of wire type metals arranged in a first direction and a plurality of wire type metals arranged in a second direction cross each other to be perpendicular to each other.

The first electrode member 510 may be formed in a circular plate shape. An opening 515 corresponding to the shape of the second electrode member 520 may be formed at a central portion of the first electrode member 510. For example, the opening 515 may be formed to have a circular shape.

The position of the opening 515 formed at a central portion of the first electrode member 510 may vary according to the buried position of a first rod connecting member (not illustrated) in contact with the high-frequency electrode 500.

The thickness of the first electrode member 510 may be 0.5 mm to 1.0 mm, and more preferably, may be 0.7 mm. In addition, the diameter d3 of the first electrode member 510 may be 300 mm to 350 mm, and more preferably, may be 320 mm.

The second electrode member 520 may be formed in a mesh structure in which a plurality of sheet type metals arranged in a first direction and a plurality of sheet type metals arranged in a second direction cross each other to be perpendicular to each other.

The second electrode member 520 may be formed in a circular plate shape having a predetermined diameter d1. In this case, the diameter d1 of the second electrode member 520 may be formed to be greater than a diameter of a contact surface of a first rod connecting member (not illustrated). In addition, the diameter d1 of the second electrode member 520 may be formed to be greater than a diameter d4 of the opening 515 formed at the first electrode member 510.

The second electrode member 520 may be formed to cover the entire opening 515 formed at a central portion of the first electrode member 510. In this case, an edge region of the second electrode member 520 may be disposed to overlap a region around the opening of the first electrode member 510. In this case, when an overlapped region between the first electrode member 510 and the second electrode member 520 is too large, since the area of the electrode comes different in the overlapped region, the size of the overlapped region is preferably formed to be 1 mm to 10 mm.

A mesh gap (that is, a pore size) of the second electrode member 520 may be formed to be identical or similar to a mesh gap of the first electrode member 510. For example, the mesh gap of the second electrode member 520 may have a range of ±50% of the mesh gap of the first electrode member 510.

The second electrode member 520 may be formed to have the thickness thinner than the first electrode member 510. For example, the thickness of the second electrode member 112b may be 0.1 to 0.5 mm, and more preferably, may be 0.2 mm. In addition, the diameter of the second electrode member 112b may be 1 mm to 10 mm, and more preferably, may be 5 mm.

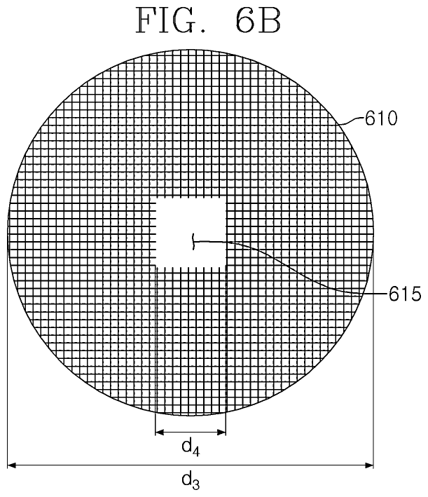

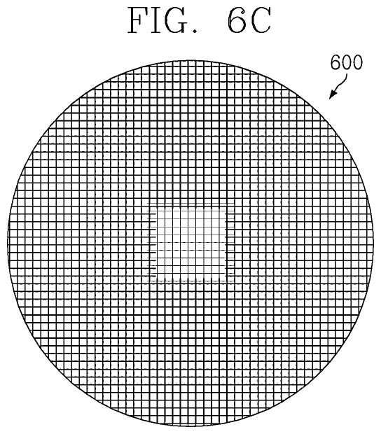

FIGS. 6A to 6C are views illustrating a shape of a high-frequency electrode according to another embodiment of the disclosure.

Referring to FIGS. 6A to 6C, a high-frequency electrode 600 according to another embodiment of the disclosure includes a first electrode member 610 having a wire type mesh structure and a second electrode member 620 having a sheet type mesh structure.

Meanwhile, since the first and second electrode members 610 and 620 of the high-frequency electrode 600 are similar to the first and second electrode members 510 and 520 of FIGS. 5A to 5C described above, the different points will be mainly described.

The first electrode member 610 may be formed to have a circular plate shape. An opening 615 corresponding to the shape of the second electrode member 620 may be formed at a central portion of the first electrode member 610. For example, the opening 615 may be formed to have a square shape.

The second electrode member 620 may be formed to have a square plate shape. In this case, a width d1 of the second electrode member 620 may be formed to be greater than the diameter of a contact surface of a first rod connecting member (not illustrated). In addition, the width d1 of the second electrode member 620 may be formed to be greater than a width d4 of the opening 615 formed at the first electrode member 610.

The second electrode member 620 may be formed to cover the entire opening 615 formed at a central portion of the first electrode member 610. In this case, an edge region of the second electrode member 620 may be disposed to overlap a region around the opening of the first electrode member 610. In this case, when an overlapped region between the first electrode member 610 and the second electrode member 620 is too large, since the area of the electrode comes different in the overlapped region, the size of the overlapped region is preferably formed to be 1 mm to 10 mm.

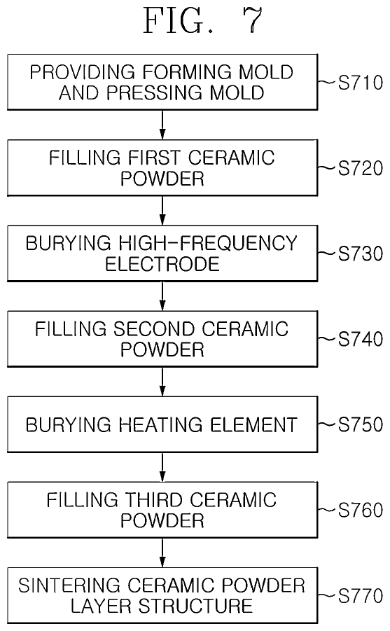

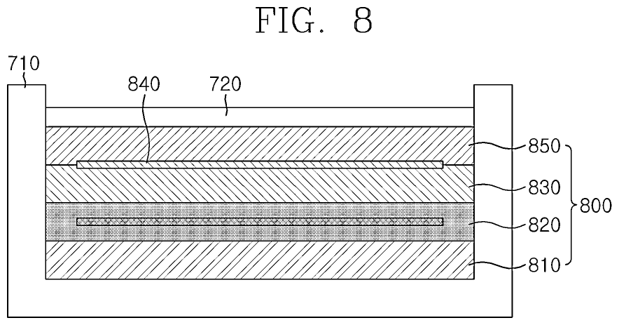

FIG. 7 is a flowchart illustrating a method for manufacturing a heater body constituting the ceramic heater in FIG. 3, and FIG. 8 is a view referred to for explaining a method for manufacturing a heater body constituting the ceramic heater in FIG. 3.

Referring to FIG. 7 and FIG. 8, a forming mold 710 (or an accommodation mold) corresponding to an overall shape of a heater body constituting the ceramic heater 100 according to an embodiment of the disclosure and a pressing mold 720 configured to apply pressure to a ceramic powder filling the forming mold 710 may be provided (S710).

A first ceramic powder may be filled in the forming mold 710 to form a first ceramic powder layer 810 (S720). A ceramic molded body 820 in which a high-frequency electrode (not illustrated) is buried may be preprocessed to be laminated on an upper portion of the first ceramic powder layer 810 in the forming mold 710 (S730). In this case, the ceramic molded body 820 may be provided in a shape of a molded body which is pressed with a predetermined pressure to maintain the shape thereof.

Then, a second ceramic powder may be filled in an upper portion of the ceramic molded body 820 in the forming mold 710 to form a second ceramic powder layer 830 (S740). Then, a heating element 840 having a spiral-shaped or mesh-shaped plate structure may be preprocessed to be buried in an upper portion of the second ceramic powder layer 830 (S750).

Next, a third ceramic powder may be filled in an upper portion of the heating element 840 in the forming mold 710 to form a third ceramic powder layer 850 (S760). The first to third ceramic powders are aluminum nitride (AlN) powders and may selectively include about 0.1 to 10%, and more preferably, about 1 to 5% of yttrium oxide powder.

After sequentially laminating the first ceramic powder layer 810, the ceramic molded body 820, the second ceramic powder layer 830, the heating element 840, and the third ceramic powder layer 850, by pressing same to a predetermined pressure by using the pressing mold 720 and providing a high temperature heat at the same time, the ceramic powder layer may be sintered to form a heater main body 800 (S770). For example, the heater body 800 may be compressively sintered at a pressure of about 0.01 to 0.3 ton/cm² and a temperature of about 1600 to 1950° C.

Hereinafter, among the elements constituting the heater body 800 described above, a method for manufacturing the ceramic molded body 820 capable of performing an RF grounding function or an electrostatic chuck function will be described in detail.

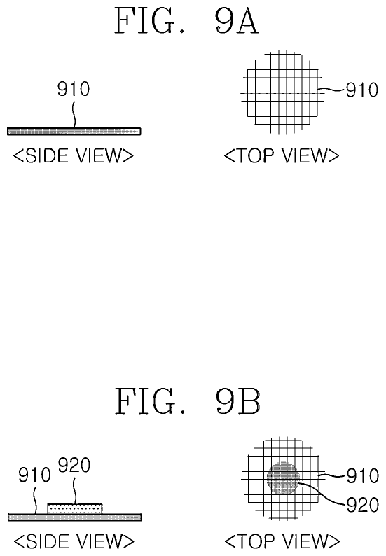

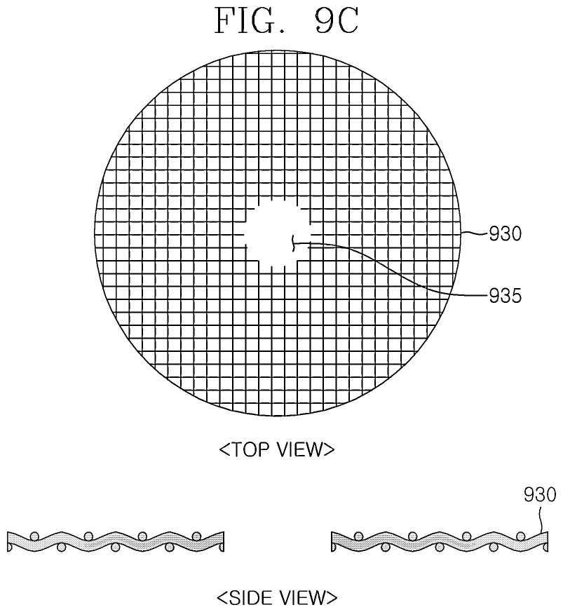

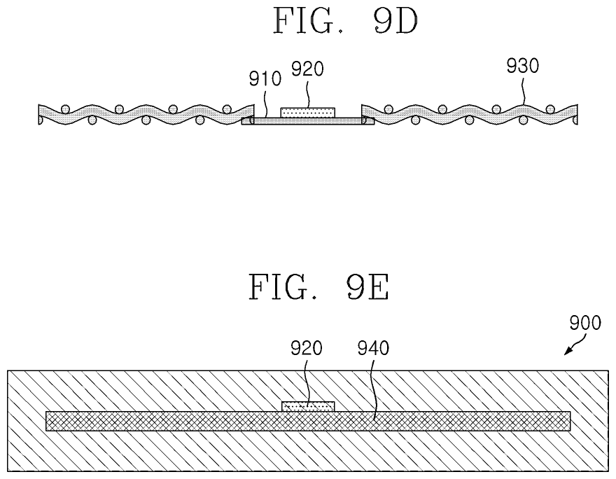

FIG. 9A to FIG. 9E are views illustrating a method for manufacturing a ceramic molded body according to an embodiment of the disclosure.

Referring to FIG. 9A, it is possible to manufacture a second electrode member 910 having a sheet type mesh structure in which a plurality of sheet type metals arranged in a first direction and a plurality of sheet type metals arranged in a second direction cross each other to be perpendicular to each other. In this case, the plurality of sheet type metals may be formed of molybdenum (Mo) having excellent electrical conductivity.

Referring to FIG. 9B, a first rod connecting member 920 may be attached to a central portion of one surface of the second electrode member having a sheet type mesh structure. In this case, the first rod connecting member 920 may be attached to the second electrode member 910 via a brazing process and is not necessarily limited thereto.

Referring to FIG. 9C, it is possible to manufacture a first electrode member 930 having a wire type mesh structure in which a plurality of wire type metals arranged in a first direction and a plurality of wire type metals arranged in a second direction cross each other to be perpendicular to each other. In this case, the plurality of wire type metals may be formed of molybdenum (Mo) having excellent electrical conductivity.

After that, a central portion of the first electrode member 930 may be cut into a predetermined shape to form an opening 935. In this case, the position of the opening 935 formed at the first electrode member 930 corresponds to the buried position of the first rod connecting member 920 in contact with a high-frequency electrode 940.

Referring to FIG. 9D, the first electrode member 930 having the opening 935 having a predetermined shape may be disposed on the second electrode member 910 to which the first rod connecting member 920 is attached. In this case, the second electrode member 910 may be disposed to cover the opening 935 formed at the first electrode member 930. In addition, the positions of the first electrode member 930 and the second electrode member 910 may be fixed by using a vacuum binder.

Referring to FIG. 9E, ceramic powder is filled around an electrode assembly disposed in a forming mold (not illustrated) and the structure laminated in the forming mold is sintered by a hot press process to manufacture a ceramic molded body 900. In this case, the first electrode member 930 and the second electrode member 910 are physically bonded to each other by the hot press process. Accordingly, the second electrode member 910 is integrally coupled with the first electrode member 930 to form one high-frequency electrode 940.

At least one of embodiments of the disclosure is advantageous in that a ceramic heater having improved reliability and a method for manufacturing the same may be provided. In addition, at least one of embodiments of the disclosure is advantageous in that a ceramic heater including a high-frequency electrode obtained by coupling a first electrode member having a wire-type mesh structure and a second electrode member a sheet-type mesh structure, and a method for manufacturing the same, may be provided.

In addition, at least one of embodiments of the disclosure is advantageous in that a high-frequency electrode obtained by integrally coupling a first electrode member having a wire-type mesh structure and a second electrode member a sheet-type mesh structure is provided such that, when a ceramic heater is manufactured by using a hot press process, delivery of uniform pressure to an area of contact between the high-frequency electrode and a first rod connecting member may be induced, thereby effectively preventing the occurrence of a crack in the area of contact.

In addition, at least one of embodiments of the disclosure is advantageous in that a high-frequency electrode obtained by integrally coupling a first electrode member having a wire-type mesh structure and a second electrode member a sheet-type mesh structure is provided such that the occurrence of a crack inside a ceramic heater or on the surface thereof may be minimized, thereby improving product reliability.

Advantageous effects obtainable by a ceramic heater and a method for manufacturing the same, according to embodiments of the disclosure, are not limited to the above-mentioned advantageous effects, and other advantageous effects not mentioned herein will be clearly understood by those skilled in the art to which the disclosure pertains.

Although specific embodiments of the disclosure have been described above, it will be obvious that various modifications are possible without departing from the scope of the disclosure. Therefore, the scope of the disclosure should not be limited to the described embodiments and should be defined not only by the claims described below but also by the claims and equivalents thereof

What is claimed is:

1. A ceramic heater comprising:
a heater body including a high-frequency electrode made of a mesh type metal material and an electrode rod connecting member in contact with a lower surface of the high-frequency electrode; and
a heater support mounted to a lower portion of the heater body to support the heater body,
wherein the high-frequency electrode includes a first electrode member having a wire type mesh structure and a second electrode member having a sheet type mesh structure.

2. The ceramic heater of claim 1, wherein the first electrode member includes a plurality of wire type metals arranged in a first direction and a plurality of wire type metals arranged in a second direction perpendicular to the first direction.

3. The ceramic heater of claim 1, wherein the first electrode member includes an opening corresponding to a shape of the second electrode member.

4. The ceramic heater of claim 3, wherein the opening is formed at a position of the first electrode member corresponding to a position of the electrode rod connecting member.

5. The ceramic heater of claim 3, wherein the second electrode member has a size larger than the opening.

6. The ceramic heater of claim 3, wherein the second electrode member is disposed to cover the opening formed at the first electrode member.

7. The ceramic heater of claim 1, wherein the second electrode member includes a plurality of sheet type metals arranged in a first direction and a plurality of sheet type metals arranged in a second direction perpendicular to the first direction.

8. The ceramic heater of claim 1, wherein the second electrode member is formed by processing a plurality of grooves on a metal sheet.

9. The ceramic heater of claim 1, wherein the second electrode member is formed to be greater than the area of a contact surface of the electrode rod connecting member in contact with the high-frequency electrode.

10. The ceramic heater of claim 1, wherein the second electrode member has a thickness thinner than the first electrode member.

11. The ceramic heater of claim 1, wherein the second electrode member is bonded to the first electrode member via a hot press process.
